(19) United States
(12) Patent Application Publication
(10) Pub. No.: US 2008/0151551 A1
(43) Pub. Date: Jun. 26, 2008

(54) Lens cap and light emitting diode package structure using the same

(75) Inventors: Cheng-Lin Yang, Hsinchu (TW); Shuang-Chao Chung, Hsinchu (TW)

Correspondence Address: BIRCH STEWART KOLASCH & BIRCH, PO BOX 747, FALLS CHURCH, VA, 22040-0747, US

(73) Assignee: INDUSTRIAL TECHNOLOGY RESEARCH INSTITUTE

(21) Appl. No.: 11/808,387

(22) Filed: Jun. 8, 2007

(30) Foreign Application Priority Data
Dec. 20, 2006 (TW) 095148045

(51) Int. Cl. F21V 13/04

(52) U.S. Cl. 362/308

(57) ABSTRACT

A lens cap and an LED package structure using the same are provided. The lens cap includes a cap body made of a transparent material for being covered on a point light source. The cap body includes a first incident surface, which is a curved surface raised on a inner side of the cap body and refracts light emitted by the point light source into the cap body. A reflective surface is formed the outer side of the cap body and is opposite to the first incident surface, wherein the reflective surface reflects the light refracted by the first incident surface. A light-transmitting surface is formed on the outer side of the cap body, and the light reflected by the reflective surface is projected onto the light-transmitting surface to exit the cap body. Thus, the light is emitted towards the lateral of the lens cap along a horizontal direction.

### CROSS-REFERENCE TO RELATED APPLICATIONS

This non-provisional application claims priority under 35 U.S.C. §119(a) on Patent Application No(s). 095148045 filed in Taiwan, R.O.C. on Dec. 20, 2006, the entire contents of which are hereby incorporated by reference.

### BACKGROUND OF THE INVENTION

1. Field of Invention

The present invention relates to a side-emitting type light emitting diode (LED) package structure, and more particularly, to a lens cap that refracts light emitted by a point source to lateral side of the lens cap and the LED package structure.

2. Related Art

Currently, light emitting diodes (LEDs) are widely applied to backlight modules of liquid crystal displays (LCDs), especially to that of small-sized LCDs. For example, the LEDs are used in the backlight modules of the LCDs of portable electronic devices or car electronic devices. The LEDs are featured in emitting monochromatic light and act as a point light source, so it is an important task on how to project the light emitted by LEDs uniformly and to mix the monochromatic light of different colors (red, green, and blue). In order to solve the aforementioned problem, a lens cap is added into an LED package structure for refracting the light and changing the direction of the light, so as to uniformly distribute the light, and to facilitate the color mixing.

U.S. Pat. No. 6,607,286 discloses a lens cap, which is a cap body covered on an LED chip. The light emitted by the LED chip enters the lens cap from the interior of the lens cap, and is then projected to a reflective surface of a curved surface profile. Then, the light is projected in a direction at an angle of about 90° to a longitudinal axis (i.e., in the horizontal direction), and is projected to the lateral of the lens cap. The reflective surface only reflects a part of the light, and the other part of the light is directly projected to the lateral of the lens cap. Therefore, a sawtooth-shaped refractive surface is formed on the outer side of the lens cap, such that the light reflected by the reflective surface and the light directly emitted from the LED chip is incident on the sawtooth-shaped refractive surface, and is refracted to an angle close to the horizontal line.

However, U.S. Pat. No. 6,607,286 has two disadvantages. Firstly, the incident angle of the light directly projected onto the reflective surface by the light source will change when the incident point is different, so in order to ensure the total reflection to occur on the reflective surface, the profile of curve of the reflective surface must be calculated precisely, which will make the design and manufacturing more difficult. Meanwhile, the light at a direction close to the longitudinal direction of the lens cap often is not totally reflected, but transmits the reflective surface partially. Secondly, the sawtooth-shaped refractive surface formed on the side of the lens cap needs to be formed by cutting or with multiple complicated molds, so the production cost and the manufacturing time will be increased, which is disadvantageous to mass production. Therefore, there are technical problems to be solved in the field of lens cap to reduce the light leakage from the refractive surface, and to lower the difficulty of production and the cost at the same time.

### SUMMARY OF THE INVENTION

In view of the above problems, the present invention provides a lens cap and a light emitting diode (LED) package structure using the same, which have simple structures, and improve the lateral luminous efficiency of the LED and reduce light leakage in a forward direction.

A lens cap of the present invention is provided to be covered on an light emitting diode (LED) chip to form an LED package. The lens cap is a cap body made of a transparent material for being covered on a point light source, e.g., an LED chip. The lens cap includes a first incident surface, a reflective surface, and a light-transmitting surface. The first incident surface is a curved surface raised on an inner side of the cap body, wherein the The first incident surface refracts the light emitted by the point light source into the cap body. The reflective surface is formed on an outer side of the cap body, and is opposite to the first incident surface, for reflecting the light refracted into the cap body by the first incident surface. The light-transmitting surface is formed on an outer side of the cap body, and the light reflected by the reflective surface is projected onto the light-transmitting surface and transmits the light-transmitting surface to exit the cap body. Thus, the light emitted by the point light source to uncertain directions is refracted to a direction in parallel with a plane where the point light source is disposed.

According to the present invention, the first incident surface inside the lens cap is used for the light emitted by the point light to be projected thereon, and the first incident surface is a curved surface raised inside the cap body, such that the divergent light emitted by the point light source converges through the refraction of the first incident surface and turns into approximately parallel light. The reflective surface can be a plane surface. By adjusting an inclined angle of the reflective surface, the incident angle of the light incident on the reflective surface is made to be greater than the total reflection angle. Thus, the total reflection occurs on the reflective surface, and the difficulty to design and manufacture the reflective surface is reduced. Meanwhile, the light-transmitting surface formed on the outer side of the lens cap is not required to be designed into an irregular type, so the difficulty to design and manufacture the light-transmitting surface is also alleviated.

The detailed features and advantages of the present invention will be described in detail in the following embodiments. Those skilled in the arts can easily understand and implement the content of the present invention. Furthermore, the relative objectives and advantages of the present invention are apparent to those skilled in the arts with reference to the content disclosed in the specification, claims, and drawings.

The description on the content of the present invention above and the description on the embodiments below are used to exemplify and explain the principle of the present invention, and provide further explanation on the claims of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1 is a side view of an LED package structure according to a first embodiment of the present invention;

FIG. 2 is a schematic sectional view of the LED package structure according to the first embodiment of the present invention;

FIG. 3 is a partial sectional view of a lens cap according to the first embodiment of the present invention;

FIG. 4 is a schematic view showing how the light proceeds in the lens cap body according to the first embodiment of the present invention;

FIG. 5 is a distribution diagram of light intensity according to the first embodiment of the present invention;

FIG. 6 is a schematic sectional view of a second embodiment of the present invention; and

FIG. 7 is a schematic sectional view of a third embodiment of the present invention.

### DETAILED DESCRIPTION OF THE INVENTION

The objectives, structures, features, and functions of the present invention will be illustrated in detail below accompanied with the embodiments.

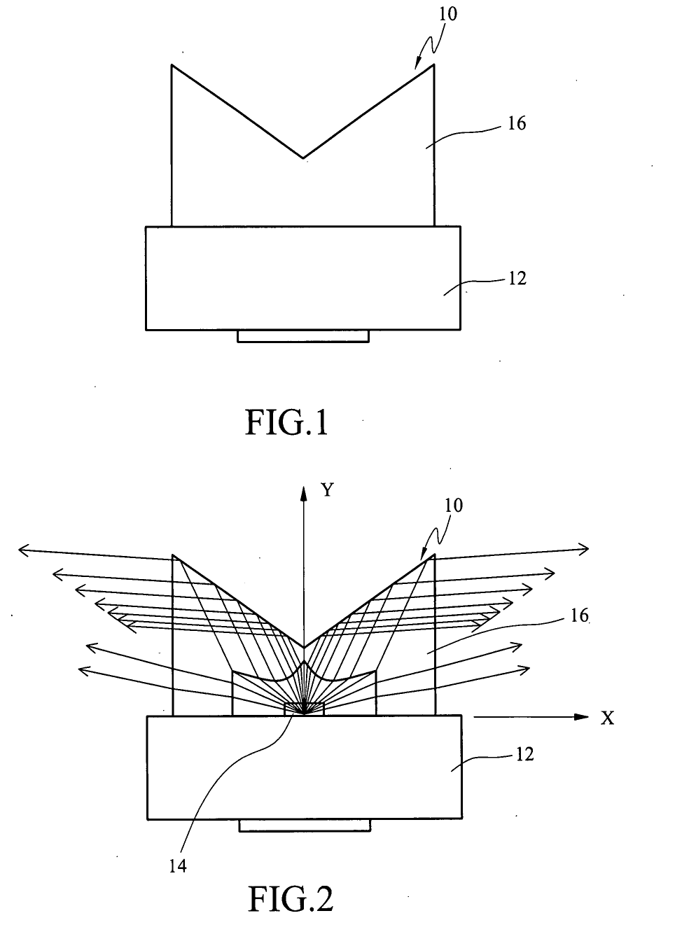

Referring to FIGS. 1 and 2, a side-emitting light emitting diode (LED) package structure 10 disclosed in a first embodiment of the present invention includes a base 12, an light emitting diode (LED) chip 14, and a cap body 16 of a lens cap. The base 12 supports the LED chip 14, and the LED chip 14 serves as a point light source, so as to emit divergent light to uncertain directions. The cap body 16 of the lens cap is fixed on the base 12, and covered on the LED chip 14, so as to refract the light emitted by the LED, such that the light is projected to the lateral of the lens cap.

The cap body 16 is made of a transparent material, and can be an independent component or be formed monolithically with the base 12. The structure of the cap body 16 is an axially symmetric structure about a longitudinal direction Y passing through the LED chip 14 serving as the point light source. Moreover, different optical structures of the cap body 16 are formed sequentially along the longitudinal axial direction Y outwardly

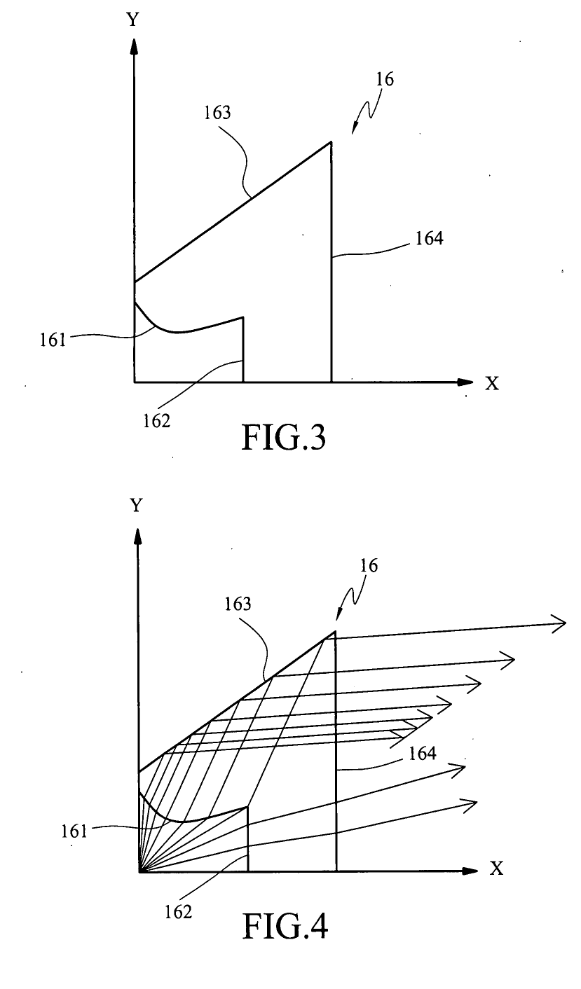

FIGS. 3 and 4 are schematic sectional views of the cap body 16, showing the structure of the cap body from the interior to the outer side along the longitudinal axial direction Y. The cap body 16 includes a first incident surface 161, a second incident surface 162, a reflective surface 163, and a light-transmitting surface 164.

The first incident surface 161 is a curved surface raised from the inner side of the cap body 16, wherein the first incident surface 161 refracts the light emitted into the cap body 16 by the LED chip 14. Taking the position where the LED chip 14 serves as the point light source as a vertex, the angle between the outer side of the first incident surface 161 and the longitudinal direction Y is smaller than 90°, and in this embodiment, the angle is about 60°. In other words, as for the light emitted by the LED chip 14, taking the longitudinal direction Y as the 0° datum, the light emitted within 0 to 60° will be projected onto the first incident surface 161, and have the refraction angle changed after being refracted to enter the cap body 16. The luminous characteristics of the LED chip 14 are similar to a point light source, and the light emitted by the LED 14 is divergent. The first incident surface 161 is raised on the inner side of the cap body 16 towards the plane where the LED chip 14 is on, so as to converge the light emitted by the LED chip 14. In other words, after the divergent light emitted by the LED chip 14 is refracted into the cap body 16 by the first incident surface 161, all of the light is converged in the cap body 16, such that the direction of the light is approximately parallel. Thus, the light refracted by the first incident surface 161 is turned into parallel light approximately.

Referring to FIGS. 3 and 4, the reflective surface 163 is formed on an outer side of the cap body 16, and is opposite to the first incident surface 161. The reflective surface 163 is provided for reflecting the light refracted into the cap body 16 by the first incident surface 161, such that the light is reflected to a direction approximately perpendicular to the longitudinal direction Y, i.e., approximately parallel to a horizontal direction X, and is projected towards the lateral of the lens cap. The reflective surface 163 can be an inclined surface at an angle to the longitudinal direction Y, and the inclined angle is determined by optical conditions. That is to say, the light from the first incident surface 161 has to be capable of being totally reflected by the reflective surface 163, and being projected towards the horizontal direction. Therefore, the inclination must match with the refractive index of the cap body 16 and the refractive index of the air (and the refractive index of the cap body must be greater than the refractive index of the air or the outside), so as to calculate the incident angle capable of generating the total reflection, and then set the angle between the reflective surface 163 and the longitudinal direction Y according to the incident angle.

Referring to FIGS. 3 and 4, the light-transmitting surface 164 is formed on the outer side the cap body 16, and is connected to the reflective surface 163 of the lens cap 16. Moreover, the light-transmitting surface 164 is substantially parallel to the longitudinal direction Y. The light reflected by the reflective surface 163 is projected onto the light-transmitting surface 164 and then, after being slightly refracted or directly transmitting according to the difference of the incident angle, the light transmits the light-transmitting surface 164 of the cap body 16, and is emitted towards the lateral of the cap body 16. As the incident angle of the totally reflected light on the reflective surface is similar, the reflective angle will also be similar. Therefore, the light-transmitting surface 164 only needs to be a plane instead of sawtooth or irregular shapes according to the difference of the incident angle. Thus, the cap body 16 can be formed and fabricated with simple molds, so as to simplify the manufacturing process and reduce the manufacturing cost.

The second incident surface 162 is formed on the inner side of the cap body 16, and is connected to the first incident surface 161. Moreover, the second incident surface 162 is approximately parallel to the longitudinal direction Y, and opposite to the light-transmitting surface 164. As described above, only the light emitted by the LED chip 14 in a predetermined angle range is projected onto the first incident surface 161, and the other part will be projected onto the second incident surface 162, such that the part of the light emitted by the LED chip 14 is refracted into the cap body 16 by the second incident surface 162, and is then projected outside the cap body 16 by the light-transmitting surface 164.

Through the structure described above, the light emitted by the LED chip 14 will be totally refracted by the cap body 16 of the lens cap, and transmit out to the lateral of the cap body 16 in a direction close to the horizontal direction X, i.e., in a direction approximately perpendicular to the longitudinal direction Y.

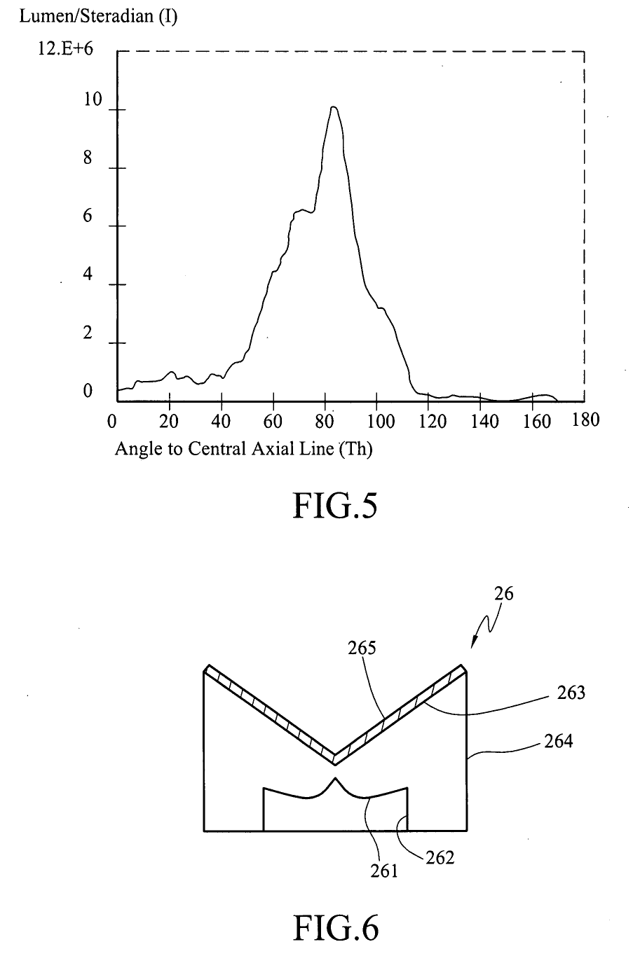

FIG. 5 is a distribution diagram of light intensity according to the first embodiment of the present invention. In FIG. 5, the longitudinal axis stands for the light intensity I, i.e., lumens passing through each unit of steradian, and the horizontal axis stands for the angle Th formed between the direction of the light exiting the cap body 16 and the longitudinal direction Y. It is known from FIG. 5 that the peak value of the light intensity I appears at the position near the angle Th of 85°, i.e., most of the light is guided to the horizontal direction X, and the light intensity I at the position near the angle Th of 0° is far smaller than the peak value. The result proves that the reflective surface 163 of this embodiment of the present invention has a preferred total reflection effect, and ensures that the light is truly reflected to the light-transmitting surface 164 when the light is incident on the reflective surface 163 and is then emitted from the horizontal direction X, so as to reduce the light leakage in the longitudinal axial direction Y. Thus, the light leakage above the cap body 16 in the figure is reduced.

FIG. 6 shows a lens cap 26 for an LED disclosed in a second embodiment of the present invention. The lens cap 26 includes a first incident surface 261, a second incident surface 262, a reflective surface 263, and a light-transmitting surface 264. In order to increase the reflectivity of the reflective surface 263, and reduce the light flux of the light leakage through the reflective surface 263 above the lens cap 26, in the second embodiment, a reflective layer 265 is formed on the reflective surface 263. Thus, the reflectivity of the reflective surface 263 is increased, and the light will not pass through the reflective surface 263 to cause light leakage.

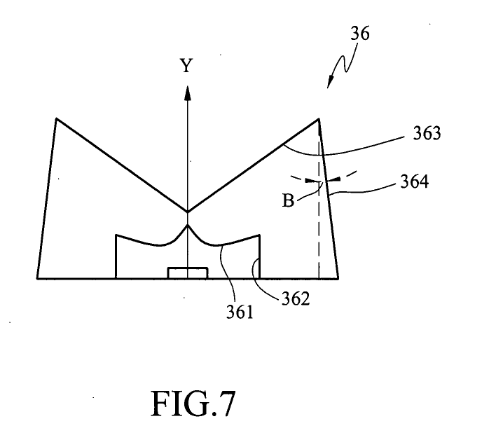

FIG. 7 shows a lens cap 36 of an LED disclosed in a third embodiment of the present invention. The lens cap 36 includes a first incident surface 361, a second incident surface 362, a reflective surface 363, and a light-transmitting surface 364. In the third embodiment, the light-transmitting surface 364 is at an angle B to the longitudinal direction Y, so as to adjust the refraction angle of the light when leaving the lens cap 36 from the light-transmitting surface 364.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A lens cap, comprising a cap body made of a transparent material and covered on a point light source, the lens cap further comprising:
a first incident surface, which is a curved surface raised on an inner side of the cap body, wherein the first incident surface refracts light emitted into the cap body by the point light source;
a reflective surface, formed on the outer side of the cap body and opposite to the first incident surface, for reflecting the light refracted into the cap body by the first incident surface; and
a light-transmitting surface, formed on the outer side of the cap body, wherein the light reflected by the reflective surface is projected onto the light-transmitting surface to transmit the light-transmitting surface to exit the cap body.

2. The lens cap as claimed in claim 1, further comprising a second incident surface connected to the first incident surface, wherein the light-transmitting surface is opposite to the second incident surface, the second incident surface is used for refracting the light emitted by the point light source into the cap body, and the light-transmitting surface projects the light to exit the cap body.

3. The lens cap as claimed in claim 1, wherein the reflective surface is an inclined surface at an angle to a longitudinal direction.

4. The lens cap as claimed in claim 1, wherein the light-transmitting surface is formed on the outer side the lens cap in parallel with the longitudinal direction.

5. The lens cap as claimed in claim 1, wherein the light-transmitting surface is at an angle to the longitudinal direction.

6. The lens cap as claimed in claim 1, further comprising a reflective layer formed on the reflective surface, for increasing the reflectivity of the reflective surface.

7. A light emitting diode package structure, comprising:
an light emitting diode chip, serving as a point light source;
a base, supporting the light emitting diode chip; and
a lens cap, including a cap body made of a transparent material fixed on the base and covered on the LED chip, wherein the lens cap further comprises:
a first incident surface, which is a curved surface raised on an inner side of the cap body, wherein the first incident surface refracts light emitted into the cap body by the point light source;
a reflective surface, formed on the outer side of the cap body and opposite to the first incident surface, for reflecting the light refracted into the cap body by the first incident surface; and
a light-transmitting surface, formed on the outer side the cap body, wherein the light reflected by the reflective surface is projected onto the light-transmitting surface to transmit the light-transmitting surface to exit the cap body.

8. The light emitting diode package structure as claimed in claim 7, further comprising a second incident surface connected to the first incident surface, wherein the light-transmitting surface is opposite to the second incident surface, the second incident surface is used for refracting the light emitted by the point light source into the cap body, and the light-transmitting surface projects the light to exit the cap body.

9. The light emitting diode package structure as claimed in claim 7, wherein the reflective surface is an inclined surface at an angle to a longitudinal direction.

10. The light emitting diode package structure as claimed in claim 7, wherein the light-transmitting surface is formed on the outer side of the cap body in parallel with the longitudinal axial direction.

11. The light emitting diode package structure as claimed in claim 7, wherein the light-transmitting surface is at an angle to the longitudinal direction.

12. The light emitting diode package structure as claimed in claim 7, further comprising a reflective layer formed on the reflective surface, for increasing the reflectivity of the reflective surface.
